(19) United States
(12) Patent Application Publication
(10) Pub. No.: US 2022/0074644 A1
(43) Pub. Date: Mar. 10, 2022

(54) APPARATUS FOR REMOVING DEW OF CAMERA FOR REFRIGERATOR AND METHOD CONTROLLING THEREOF

(71) Applicant: WINIA ELECTRONICS CO., LTD., Gwangju (KR)

(72) Inventor: Jeong Keun KIM, Gwangju (KR)

(73) Assignee: WINIA ELECTRONICS CO., LTD., Gwangju (KR)

(21) Appl. No.: 17/408,761

(22) Filed: Aug. 23, 2021

(30) Foreign Application Priority Data
Aug. 21, 2020 (KR) 10-2020-0105528

(51) Int. Cl. F25D 23/02

(52) U.S. Cl. CPC F25D 23/028; F25D 2700/02

(57) ABSTRACT

A dew removing device for a refrigerator camera and a method of controlling the same are disclosed. The method comprises a step S1 of, when a refrigerator door is opened, turning on a power of a camera unit and a power of a resistor; a step S2 of, when a set time has passed after the step S1, turning off the power of the camera unit and the power of the resistor; and a step S3 of, when the refrigerator door is closed before the set time has passed after the step S1, turning on a power of a lighting unit after a first dew removal time has passed, and capturing an inside of a storage compartment by the camera unit. The method can provide a user with a clear image of a food storage state by removing a dew generated on the lens surface of the camera.

### CROSS-REFERENCE TO RELATED APPLICATIONS

This application claims the benefit of Korea Patent Application No. 10-2020-0105528, filed on Aug. 21, 2020, which is incorporated herein by reference for all purposes as if fully set forth herein.

### TECHNICAL FIELD

The present disclosure relates to a dew removing device for a refrigerator camera and a method of controlling the same that can quickly and accurately send the latest storage state of food in a storage compartment to a user by removing a dew generated on a lens surface of a camera unit using heat generation characteristic of a resistor in a short time.

### BACKGROUND

A general refrigerator is provided with storage compartments such as a freezer compartment or a refrigerator compartment therein and is configured to freeze food stored in the storage compartment or store food for a long time at a low temperature using a cold air generated by a refrigeration cycle.

The refrigerator may be provided with a camera unit that can captures the inside of the storage compartment in order to check the inside of the storage compartment without opening a refrigerator door of the refrigerator.

A related art refrigerator provided with a camera unit is disclosed in Korean Patent Application Publication No. 10-2018-0029008 (published Mar. 19, 2018 titled, “Refrigerator”).

When the refrigerator door is opened, moisture in the air condenses on a lens surface of a camera unit, that captures the inside of the storage compartment of the refrigerator, in the form of dew due to a sudden temperature change.

In order to prevent the dew formation, the above document is described such that a heating wire is provided around the camera unit.

However, since the heating wire generates heat through an electric current, there is a problem that a large amount of power is consumed, which causes an increase in power consumption.

In addition, since a separate heating wire needs to be installed around the camera unit, there is a problem in that assembly and production efficiency are deteriorated due to the addition of the number of processes.

### SUMMARY

An object of the present disclosure is to address the above-described and other needs and/or problems. Another object of the present disclosure is to provide a dew removing device for a refrigerator camera and a method of controlling the same that can accurately provide a user with a clear image showing change in a storage state of food in a storage compartment as quickly as possible by removing dew generated on the surface of a lens of a camera unit using heat generation characteristic of a resistor in a short time.

In one aspect of the present disclosure, there is provided a dew removing device for a refrigerator camera comprising a camera unit configured to capture an inside of a storage compartment; and a resistor provided on a substrate inside the camera unit and disposed around a lens of the camera unit, wherein the resistor is configured to remove a dew generated on a surface of the lens by converting applied power into thermal energy.

In another aspect of the present disclosure, there is provided a method of controlling a dew removal of a refrigerator camera, the method comprising a step S1 of, when a refrigerator door is opened, turning on a power of a camera unit and a power of a resistor; a step S2 of, when a set time has passed after the step S1, turning off the power of the camera unit and the power of the resistor; and a step S3 of, when the refrigerator door is closed before the set time has passed after the step S1, turning on a power of a lighting unit after a first dew removal time has passed, and capturing an inside of a storage compartment by the camera unit.

The first dew removal time is a time required to remove a dew generated on a surface of a lens of the camera unit in a general use environment.

The method further comprises a step S4 of, after a second dew removal time has passed after the step S3, recapturing the inside of the storage compartment by the camera unit.

The second dew removal time is a time required to remove a dew generated on a surface of a lens of the camera unit in a high-temperature and high-humidity use environment.

The method further comprises a step S5 of, after the step S4, turning off the power of the camera unit, the power of the resistor, and the power of the lighting unit.

A dew removing device for a refrigerator camera and a method of controlling the same according to the present disclosure have the following effects.

The present disclosure can accurately provide a user with a clear image showing change in a storage state of food in the storage compartment as quickly as possible by removing dew generated on the surface of the lens of the camera unit using heat generation characteristic of the resistor in a short time.

The present disclosure is configured such that the resistor is provided on the substrate inside the camera unit, and thus can be easy to assemble since the resistor only needs to be mounted on the substrate, on which the lens is mounted, without including a separate dew removing device. Furthermore, when the power of the camera unit is turned on, the resistor is also turned on, and when the power of the camera unit is turned off, the resistor is also turned off. Thus, since there is no need to add a separate power supply device, the present disclosure can reduce the production cost.

The present disclosure can minimize a dew removal time by applying power to the camera unit and the resistor at the moment that the refrigerator door is opened and controlling to start the heat generation.

When a set time has passed after the refrigerator door is opened, the present disclosure controls the power of the camera unit and the power of the resistor to be turned off. Hence, the present disclosure can fundamentally prevent the case where an image sensor operation guarantee temperature of the camera unit may be exceeded when a user keeps the refrigerator door open.

Furthermore, when the refrigerator door is closed, the present disclosure first captures the inside of the storage compartment and transmits the captured picture, and then the present disclosure secondly captures the inside of the storage compartment and transmits the captured picture. Therefore, a camera control board first transmits the picture to the server based on a general use condition and can allow the user to check the latest picture of the inside of the storage compartment as quickly as possible. Thereafter, the camera control board can allow the user to finally check a clear picture of the inside of the storage compartment even in the high-temperature and high-humidity environment through the second capturing. Hence, the present disclosure can further enhance the user convenience.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIGS. 1 and 2 illustrate a dew removing device for a refrigerator camera according to an embodiment of the present disclosure.

FIG. 3 is a flow chart illustrating a method of controlling a dew removal of a refrigerator camera according to an embodiment of the present disclosure.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In general, a suffix such as “module” and “unit” may be used to refer to elements or components. Use of such a suffix herein is merely intended to facilitate description of the present disclosure, and the suffix itself is not intended to give any special meaning or function. It will be noted that a detailed description of known arts will be omitted if it is determined that the detailed description of the known arts can obscure the embodiments of the disclosure.

The accompanying drawings are used to help easily understand various technical features and it should be understood that embodiments presented herein are not limited by the accompanying drawings. As such, the present disclosure should be construed to extend to any alterations, equivalents and substitutes in addition to those which are particularly set out in the accompanying drawings.

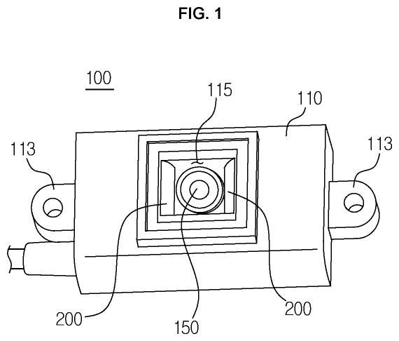

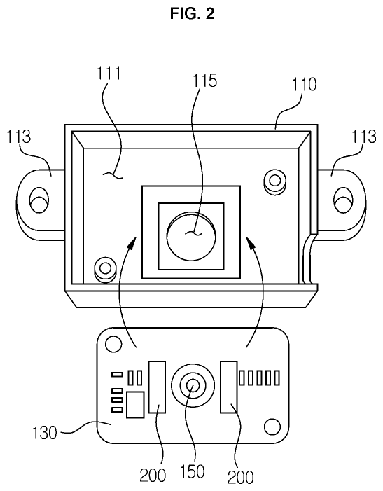

As illustrated in FIGS. 1 and 2, a dew removing device for a refrigerator camera according to an embodiment of the present disclosure includes a camera unit 100 and a resistor 200.

The camera unit 100 is configured to capture the inside of a storage compartment of a refrigerator and is provided to be mounted at any position inside the storage compartment. In other embodiments, the number and positions of the camera units 100 may be changed.

In this embodiment, as illustrated in FIG. 2, the camera unit 100 includes a case 110, a substrate 130, a lens 150, an image sensor (not shown), and the like.

The case 110 is provided with an inner space 111 so that the substrate 130 can be accommodated. A fastening part 113 mounted with a fastening means is provided outside the case 110 so that the camera unit 100 can be mounted at a desired position in the storage compartment. A lens exposure hole 115 is formed at a front surface of the case 110.

The substrate 130 is provided in the inner space 111 of the case 110, and the lens 150 for capturing is mounted on the substrate 130.

The lens 150 mounted on the substrate 130 is exposed to the outside through the lens exposure hole 115 of the case 110, and thus can easily capture the inside of the storage compartment.

The image sensor may be a semiconductor that converts light entering through the lens 150 into a digital signal and displays it as an image.

As illustrated in FIG. 2, the resistor 200 is provided on the substrate 130 inside the camera unit 100. The resistor 200 is disposed around the lens 150 of the camera unit 100 and allows dew generated on the surface of the lens 150 to be removed by converting the applied power into thermal energy. The resistor 200 is configured to limit the flow of electric current. When the electric current flows, the resistor 200 consumes the power and emits thermal energy.

In this embodiment, the resistors 200 are respectively disposed on both sides of the lens 150 of the substrate 130 provided inside the case 110. In other words, a pair of resistors 200 face each other around the lens 150 and are arranged in parallel with each other. Since the resistor 200 is configured to remove the dew generated on the surface of the lens 150, the resistor 200 only needs to be disposed around the lens 150, and the number and arrangement of the resistors 200 may be changed according to embodiments.

As described above, the dew removing device for the refrigerator camera according to an embodiment of the present disclosure is configured such that the resistor 200 is provided on the substrate 130 inside the camera unit 100, and thus can be easy to assemble since the resistor 200 only needs to be mounted on the substrate 130, on which the lens 150 is mounted, without including a separate dew removing device. Further, when the power of the camera unit 100 is turned on, the resistor 200 is also turned on, and when the power of the camera unit 100 is turned off, the resistor 200 is also turned off. Thus, since there is no need to add a separate power supply device, the production cost can be reduced.

As described above, the present disclosure can accurately provide a user with a clear image showing change in a storage state of food in the storage compartment as quickly as possible by removing the dew generated on the surface of the lens 150 of the camera unit 100 using heat generation characteristic of the resistor 200 in a short time.

Although not shown in the drawings, when the refrigerator door is closed, the inside of the storage compartment becomes dark. Therefore, in order to smoothly capture the inside of the storage compartment, it is preferable that a lighting unit, which is a lighting device for capturing, is provided inside the storage compartment. The lighting unit is provided at a position where the camera unit 100 irradiates light to a portion to be captured, and thus the number and position of the lighting units can be changed according to embodiments.

In the dew removing device for the refrigerator camera configured as described above, a method of controlling the dew removal of the refrigerator camera may be implemented as follows.

The moment that the refrigerator door is opened, dew formation occurs on the surface of the lens 150 of the camera unit 100 depending on changes in temperature and humidity. In order to minimize time required to remove the dew, the present disclosure applies power to the camera unit 100 and the resistor 200 at the moment that the refrigerator door is opened, and controls to start the heat generation.

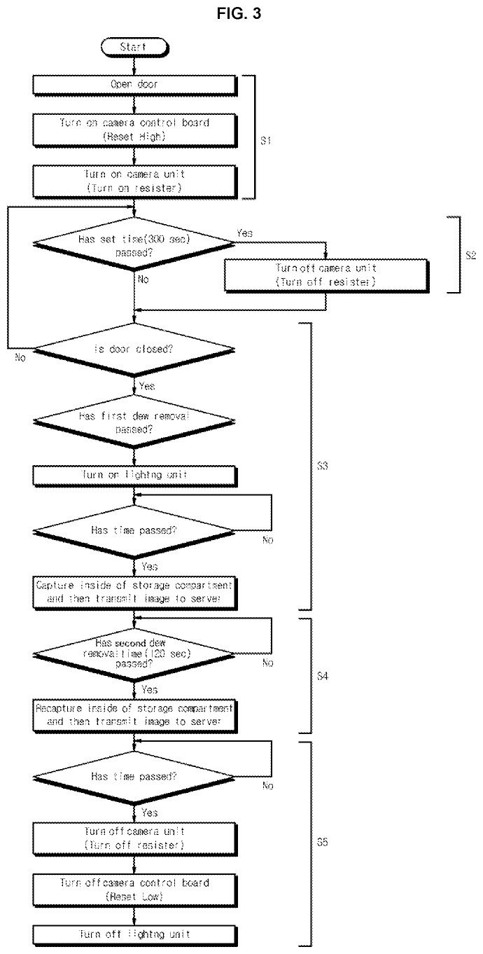

To this end, as illustrated in FIG. 3, when the refrigerator door is opened, the power of the camera unit 100 and the power of the resistor 200 are turned on, in step S1. More specifically, a camera control board is turned on, and the camera control board applies power to the camera unit 100 and the resistor 200 and starts the heat generation of the resistor 200. The camera control board may serve to control the power of the camera unit 100 and the resistor 200, correct a picture taken by the camera unit 100, and transmit it to a server. In the present disclosure, since the resistor 200 is provided on the substrate 130 inside the camera unit 100, power is also applied to the resistor 200 when power is applied to the camera unit 100.

When the user keeps the refrigerator door open, an image sensor operation guarantee temperature of the camera unit 100 may be exceeded. Therefore, a control method of cutting off power of the camera unit 100 and the resistor 200 is required after a predetermined time has passed.

To this end, when a set time has passed after the step S1, the power of the camera unit 100 and the power of the resistor 200 are turned off. More specifically, the camera control board cuts off the power of the camera unit 100 and the resistor 200. In this instance, in the present disclosure, since the resistor 200 is provided on the substrate 130 inside the camera unit 100, power of the resistor 200 is also cut off when power of the camera unit 100 is cut off. The set time may be set within 300 seconds.

When the closing of the refrigerator door is detected, the present disclosure is configured to take a picture of the inside of the storage compartment and transmit an image of the picture to the server.

To this end, when the refrigerator door is closed before the set time has passed after the step S1, the power of the lighting unit is turned on after a first dew removal time has passed, and the camera unit 100 captures the inside of the storage compartment, in step S3. In this instance, after a predetermined time has passed after the power of the lighting unit is turned on, the camera unit 100 may be configured to capture the inside of the storage compartment.

In the present disclosure, the first dew removal time refers to a time required to remove dew generated on the surface of the lens 150 of the camera unit 100 in a general use environment (e.g., 25° C., 50%).

After a second dew removal time has passed after the step S3, the camera unit 100 recaptures the inside of the storage compartment, in step S4.

In the present disclosure, the second dew removal time refers to a time required to remove dew generated on the surface of the lens 150 of the camera unit 100 in a high-temperature and high-humidity use environment (e.g., 40° C., 90%). The second dew removal time may be within 120 seconds.

As above described, when the refrigerator door is closed, the method first captures the inside of the storage compartment and transmits the captured picture to the server, and then the method secondly captures the inside of the storage compartment and transmits the captured picture to the server. Therefore, the camera control board first transmits the picture to the server based on the general use condition and can allow the user to check the latest picture of the inside of the storage compartment as quickly as possible. Thereafter, the camera control board can allow the user to finally check a clear picture of the inside of the storage compartment even in the high-temperature and high-humidity environment through the second capturing. Hence, the present disclosure can further enhance the user convenience.

After the step S4, the power of the camera unit 100, the power of the resistor 200, and the power of the lighting unit are turned off, in step S5. More specifically, the power of the camera unit 100 and the power of the resistor 200 are cut off after a predetermined time has passed, and then the power of the camera control board is turned off. Afterwards, the power of the lighting unit is turned off, and hence power consumption can be reduced.

The method of controlling the dew removal of the refrigerator camera according to the present disclosure as described above can minimize the dew removal time by applying power to the camera unit 100 and the resistor 200 at the moment that the refrigerator door is opened and controlling to start the heat generation.

When the set time has passed after the refrigerator door is opened, the present disclosure controls the power of the camera unit 100 and the resistor 200 to be turned off. Hence, the present disclosure can fundamentally prevent the case where the image sensor operation guarantee temperature of the camera unit 100 may be exceeded when the user keeps the refrigerator door open.

Furthermore, when the refrigerator door is closed, the method first captures the inside of the storage compartment and transmits the captured picture, and then the method secondly captures the inside of the storage compartment and transmits the captured picture. Therefore, the camera control board first transmits the picture to the server based on the general use condition and can allow the user to check the latest picture of the inside of the storage compartment as quickly as possible. Thereafter, the camera control board can allow the user to finally check a clear picture of the inside of the storage compartment even in the high-temperature and high-humidity environment through the second capturing. Hence, the present disclosure can further enhance the user convenience.

Although the embodiments have been described with reference to a number of illustrative embodiments thereof, numerous other modifications and embodiments may be devised by those skilled in the art that will fall within the scope of the principles of the present disclosure. In particular, various variations and modifications are possible in the component parts and/or arrangements of the subject combination arrangement within the scope of the present disclosure, the drawings and the appended claims. In addition to variations and modifications in the component parts and/or arrangements, alternative uses will also be apparent to those skilled in the art. The scope of the present disclosure should be determined by rational interpretation of the appended claims, and all modifications within an equivalent scope of the present disclosure are included in the scope of the present disclosure.

What is claimed is:

1. A dew removing device for a refrigerator camera comprising:
a camera unit configured to capture an inside of a storage compartment; and
a resistor provided on a substrate inside the camera unit and disposed around a lens of the camera unit,
wherein the resistor is configured to remove a dew generated on a surface of the lens by converting applied power into thermal energy.

2. A method of controlling a dew removal of a refrigerator camera, the method comprising:
a step S1 of, when a refrigerator door is opened, turning on a power of a camera unit and a power of a resistor;
a step S2 of, when a set time has passed after the step S1, turning off the power of the camera unit and the power of the resistor; and
a step S3 of, when the refrigerator door is closed before the set time has passed after the step S1, turning on a power of a lighting unit after a first dew removal time has passed, and capturing an inside of a storage compartment by the camera unit.

3. The method of claim 2, wherein the first dew removal time is a time required to remove a dew generated on a surface of a lens of the camera unit in a general use environment.

4. The method of claim 2, further comprising:
a step S4 of, after a second dew removal time has passed after the step S3, recapturing the inside of the storage compartment by the camera unit.

5. The method of claim 4, wherein the second dew removal time is a time required to remove a dew generated on a surface of a lens of the camera unit in a high-temperature and high-humidity use environment.

6. The method of claim 4, further comprising:
a step S5 of, after the step S4, turning off the power of the camera unit, the power of the resistor, and the power of the lighting unit.
